(19) United States
(12) Patent Application Publication
(10) Pub. No.: US 2026/0120406 A1
(43) Pub. Date: Apr. 30, 2026

(54) CLASSIFY TO REGRESS FRAMEWORK FOR PARAMETRIC REPRESENTATION OF FACIAL AVATARS

(71) Applicant: QUALCOMM Incorporated, San Diego, CA (US)

(72) Inventors: Mohit LAMBA, New Delhi (IN); Anupama S., Chennai (IN); Srenivas VARADARAJAN, Bangalore (IN)

(21) Appl. No.: 19/226,026

(22) Filed: Jun. 2, 2025

Related U.S. Application Data
(60) Provisional application No. 63/714,024, filed on Oct. 30, 2024.

(51) Int. Cl. G06T 17/20; G06T 13/40; G06V 10/764; G06V 10/766; G06V 10/776; G06V 40/16

(52) U.S. Cl. CPC G06T 17/20; G06T 13/40; G06V 10/764; G06V 10/766; G06V 10/776; G06V 40/172; G06V 40/174

(57) ABSTRACT

Systems and techniques are described herein for generating a mesh mode. For instance, a process can include obtaining a plurality of identified parameters associated with a selected expression of a first face in a set of images, wherein a range of the identified plurality of parameters is divided into a plurality of buckets, and wherein each bucket of the plurality of buckets is associated with a respective class label; generating, by an encoder configured to generate a three-dimensional mesh model, a set of parameters describing a second face in at least one image; determining a bucket from the plurality of buckets for a parameter from the set of parameters; and classifying the parameter from the set of parameters using a class label associated with the determined bucket.

### CROSS-REFERENCE TO RELATED APPLICATIONS

This application claims the benefit of U.S. Provisional Patent Application No. 63/714,024, filed Oct. 30, 2024, which is hereby incorporated by reference in its entirety and for all purposes.

### TECHNICAL FIELD

The present disclosure generally relates to virtual content for virtual environments or partially virtual environments. For example, aspects of the present disclosure include systems and techniques that provide a framework for parametric representation of facial avatars.

### BACKGROUND

An extended reality (XR) (e.g., virtual reality (VR), augmented reality (AR), mixed reality (MR)) system can provide a user with a virtual experience by immersing the user in a completely virtual environment (made up of virtual content) and/or can provide the user with an augmented or mixed reality experience by combining a real-world or physical environment with a virtual environment.

One example use case for XR content that provides virtual, augmented, or mixed reality to users is to present a user with a “metaverse” experience. The metaverse is essentially a virtual universe that includes one or more three-dimensional (3D) virtual worlds. For example, a metaverse virtual environment may allow a user to virtually interact with other users (e.g., in a social setting, in a virtual meeting, etc.), to virtually shop for goods, services, property, or other item, to play computer games, and/or to experience other services.

In some cases, a user may be represented in a virtual environment (e.g., a metaverse virtual environment) as a virtual representation of the user, sometimes referred to as an avatar. In any virtual environment, it is important for a system to generate high-quality avatars representing a person in a highly efficient and low-latency manner.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example, a method for generating a mesh model is provided. The method includes: obtaining a plurality of identified parameters associated with a selected expression of a first face in a set of images, wherein a range of the identified plurality of parameters is divided into a plurality of buckets, and wherein each bucket of the plurality of buckets is associated with a respective class label; generating, by an encoder configured to generate a three-dimensional mesh model, a set of parameters describing a second face in at least one image; determining a bucket from the plurality of buckets for a parameter from the set of parameters; and classifying the parameter from the set of parameters using a class label associated with the determined bucket.

As another example, an apparatus for generating a mesh model is provided. The apparatus includes at least one memory and at least one processor coupled to the at least one memory and configured to: obtain a plurality of identified parameters associated with a selected expression of a first face in a set of images, wherein a range of the identified plurality of parameters is divided into a plurality of buckets, and wherein each bucket of the plurality of buckets is associated with a respective class label; generate, by an encoder configured to generate a three-dimensional mesh model, a set of parameters describing a second face in at least one image; determine a bucket from the plurality of buckets for a parameter from the set of parameters; and classify the parameter from the set of parameters using a class label associated with the determined bucket.

In another example, a non-transitory computer-readable medium having stored thereon instructions is provided. The instructions, when executed by at least one processor, cause the at least one processor to: obtain a plurality of identified parameters associated with a selected expression of a first face in a set of images, wherein a range of the identified plurality of parameters is divided into a plurality of buckets, and wherein each bucket of the plurality of buckets is associated with a respective class label; generate, by an encoder configured to generate a three-dimensional mesh model, a set of parameters describing a second face in at least one image; determine a bucket from the plurality of buckets for a parameter from the set of parameters; and classify the parameter from the set of parameters using a class label associated with the determined bucket.

As another example, an apparatus for generating a mesh model is provided. The apparatus includes: means for obtaining a plurality of identified parameters associated with a selected expression of a first face in a set of images, wherein a range of the identified plurality of parameters is divided into a plurality of buckets, and wherein each bucket of the plurality of buckets is associated with a respective class label; means for generating, by an encoder configured to generate a three-dimensional mesh model, a set of parameters describing a second face in at least one image; means for determining a bucket from the plurality of buckets for a parameter from the set of parameters; and means for classifying the parameter from the set of parameters using a class label associated with the determined bucket.

In another example, an apparatus for generating a mesh model is provided. The apparatus includes at least one memory and at least one processor coupled to the at least one memory and configured to: generate, based on an obtained frame, a set of parameters for a three-dimensional (3D) mesh model using an encoder, wherein the encoder is trained based on whether a parameter, of the set of parameters, is classified within a bucket, and wherein the bucket is defined based on an upper bound value for the parameter and a lower bound value for the parameter; and generate the 3D mesh model based on the set of parameters for the 3D mesh model.

As another example, a method for generating a mesh model is provided. The method includes: generating, based on an obtained frame, a set of parameters for a three-dimensional (3D) mesh model using an encoder, wherein the encoder is trained based on whether a parameter, of the set of parameters, is classified within a bucket, and wherein the bucket is defined based on an upper bound value for the parameter and a lower bound value for the parameter; and generating the 3D mesh model based on the set of parameters for the 3D mesh model.

In another example, a non-transitory computer-readable medium having stored thereon instructions is provided. The instructions, when executed by at least one processor, cause the at least one processor to: generate, based on an obtained frame, a set of parameters for a three-dimensional (3D) mesh model using an encoder, wherein the encoder is trained based on whether a parameter, of the set of parameters, is classified within a bucket, and wherein the bucket is defined based on an upper bound value for the parameter and a lower bound value for the parameter; and generate the 3D mesh model based on the set of parameters for the 3D mesh model.

As another example, an apparatus for generating a mesh model is provided. The apparatus includes: means for generating, based on an obtained frame, a set of parameters for a three-dimensional (3D) mesh model using an encoder, wherein the encoder is trained based on whether a parameter, of the set of parameters, is classified within a bucket, and wherein the bucket is defined based on an upper bound value for the parameter and a lower bound value for the parameter; and means for generating the 3D mesh model based on the set of parameters for the 3D mesh model.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of an extended reality (XR) system, according to aspects of the disclosure;

FIG. 2 is a diagram illustrating an example of a three-dimensional (3D) collaborative virtual environment, according to aspects of the disclosure;

FIG. 3 is an image with a virtual representation (an avatar) of a user, according to aspects of the disclosure;

FIG. 4 is a diagram illustrating another example of an XR system, according to aspects of the disclosure;

FIG. 5 is a diagram illustrating an example configuration of a client device, according to aspects of the disclosure;

FIG. 6 is a diagram illustrating an example of a normal map, an albedo map, and a specular reflection map, according to aspects of the disclosure;

FIG. 7 is a diagram illustrating an example of one technique for performing avatar animation, according to aspects of the disclosure;

FIG. 8 is a diagram illustrating an example of performing facial animation with blendshapes, according to aspects of the disclosure;

FIG. 9 is a diagram illustrating an example of a system that can generate a 3D Morphable Model (3DMM) face mesh, according to aspects of the disclosure;

FIG. 10 is a diagram illustrating an example of animating an avatar, according to aspects of the disclosure;

FIG. 11A illustrates an example of annotating a face, in accordance with aspects of the present disclosure;

FIG. 11B illustrates examples of classifying an expression for a face, in accordance with aspects of the present disclosure; is a diagram illustrating an example of using a 3DMM fitting curve to drive a virtual representation (or avatar) with a metahuman, according to aspects of the disclosure;

FIG. 12 is a diagram illustrating how a classify to regress framework may be used 1200, in accordance with aspects of the present disclosure;

FIG. 13 is a flow diagram illustrating operations of a classify to regress framework 1300, in accordance with aspects of the present disclosure;

FIG. 14A illustrates examples of a closing eye, in accordance with aspects of the present disclosure;

FIG. 14B illustrates additional examples of labels for buckets for other parameters, in accordance with aspects of the present disclosure;

FIG. 15 illustrates class buckets, labels, and ranges for parameters of a set of parameters, in accordance with aspects of the present disclosure;

FIG. 16 is a flow diagram illustrating a process for generating a mesh model, in accordance with aspects of the present disclosure;

FIG. 17 is a flow diagram illustrating a process for generating a mesh model, in accordance with aspects of the present disclosure; and

FIG. 18 is a diagram illustrating an example of a computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs), smart glasses (e.g., AR glasses, MR glasses, etc.), among others.

XR systems can include virtual reality (VR) systems facilitating interactions with VR environments, augmented reality (AR) systems facilitating interactions with AR environments, mixed reality (MR) systems facilitating interactions with MR environments, and/or other XR systems. For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include any virtual content, such as video, images, graphic content, location data (e.g., global positioning system (GPS) data or other location data), sounds, any combination thereof, and/or other augmented content. An AR system is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. A virtual representation (or avatar) may be generated/animated on real-time based on captured input from user devices. Avatars may range from basic synthetic 3D representations to more realistic representations of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

For instance, in the example of the 3D collaborative virtual environment from above, an XR system of a user from the group of users may display virtual representations (or avatars) of the other users sitting at specific locations at a virtual table or in a virtual room. The virtual representations of the users and the background of the virtual environment should be displayed in a realistic manner (e.g., as if the users were sitting together in the real world). The heads, bodies, arms, and hands of the users can be animated as the users move in the real world. Audio may need to be spatially rendered or may be rendered monophonically. Latency in rendering and animating the virtual representations should be minimal in order to maintain a high-quality user experience.

Virtual representations may be rendered using 3D mesh (e.g., morphological) models (3DMMs). These 3DMM may be generated using ML based decoders trained using a 3D ground truth mesh model or detailed 2D annotations. However, obtaining a 3D ground truth or creating detailed 2D annotations for contours and landmarks for a diverse range of expressions is a formidable undertaking. This process can involve multiple steps, including the installation of prudently calibrated camera rigs and the hiring of multiple human annotators. Moreover, these efforts come with significant costs, potentially reaching millions of dollars. Additionally, the turnaround time for obtaining accurate annotations can be prohibitively long. Further, these annotations may still suffer from subjectivity and noise. The inherent challenges, along with the use of limited data and inconsistent ground-truth labels, can lead to inaccurate and unstable results during model fine-tuning. In some cases, techniques to reduce these costs and challenges may be useful.

Systems, apparatuses, electronic devices, methods (also referred to as processes), and computer-readable media (collectively referred to herein as “systems and techniques”) are described herein for providing techniques for classification to regress for parametric representation of facial avatars. For example, it may be useful to annotate the positions of these movable parts as broad classes rather than accurate contours and associate them with specific 3DMM coefficients responsible for those motions. In some cases, an encoder may generate, based on an obtained frame, a set of parameters for a 3D mesh model. This encoder may be trained based on whether a parameter, of the set of parameters, is classified within a bucket (e.g., bin, range, class, etc.), and wherein the bucket is defined based on an upper bound value for the parameter and a lower bound value for the parameter. The encoder may also be trained based on a loss determined based on a comparison of the bucket the parameter is classified within and a ground truth bucket for the obtained frame. The loss may be determined based on the upper bound value for the parameter and the lower bound value for the parameter. In some cases, the upper bound value for the parameter and the lower bound value for the parameter are determined based on how the 3D mesh model appears within the upper bound value for the parameter and the lower bound value for the parameter.

Various aspects of the application will be described with respect to the figures.

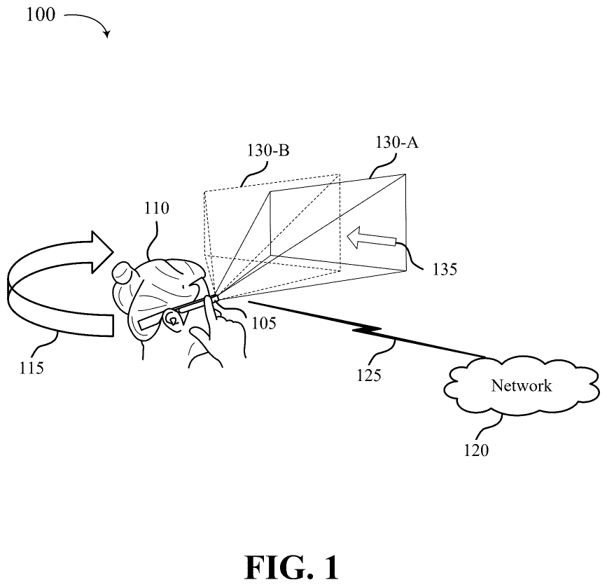

FIG. 1 illustrates an example of an extended reality system 100. As shown, the extended reality system 100 includes a device 105, a network 120, and a communication link 125. In some cases, the device 105 may be an extended reality (XR) device, which may generally implement aspects of extended reality, including virtual reality (VR), augmented reality (AR), mixed reality (MR), etc. Systems including a device 105, a network 120, or other elements in extended reality system 100 may be referred to as extended reality systems.

The device 105 may overlay virtual objects with real-world objects in a view 130. For example, the view 130 may generally refer to visual input to a user 110 via the device 105, a display generated by the device 105, a configuration of virtual objects generated by the device 105, etc. For example, view 130-A may refer to visible real-world objects (also referred to as physical objects) and visible virtual objects, overlaid on or coexisting with the real-world objects, at some initial time. View 130-B may refer to visible real-world objects and visible virtual objects, overlaid on or coexisting with the real-world objects, at some later time. Positional differences in real-world objects (e.g., and thus overlaid virtual objects) may arise from view 130-A shifting to view 130-B at 135 due to head motion 115. In another example, view 130-A may refer to a completely virtual environment or scene at the initial time and view 130-B may refer to the virtual environment or scene at the later time.

Generally, device 105 may generate, display, project, etc. virtual objects and/or a virtual environment to be viewed by a user 110 (e.g., where virtual objects and/or a portion of the virtual environment may be displayed based on user 110 head pose prediction in accordance with the techniques described herein). In some examples, the device 105 may include a transparent surface (e.g., optical glass) such that virtual objects may be displayed on the transparent surface to overlay virtual objects on real word objects viewed through the transparent surface. Additionally or alternatively, the device 105 may project virtual objects onto the real-world environment. In some cases, the device 105 may include a camera and may display both real-world objects (e.g., as frames or images captured by the camera) and virtual objects overlaid on displayed real-world objects. In various examples, device 105 may include aspects of a virtual reality headset, smart glasses, a live feed video camera, a GPU, one or more sensors (e.g., such as one or more IMUs, image sensors, microphones, etc.), one or more output devices (e.g., such as speakers, display, smart glass, etc.), etc.

In some cases, head motion 115 may include user 110 head rotations, translational head movement, etc. The device 105 may update the view 130 of the user 110 according to the head motion 115. For example, the device 105 may display view 130-A for the user 110 before the head motion 115. In some cases, after the head motion 115, the device 105 may display view 130-B to the user 110. The extended reality system (e.g., device 105) may render or update the virtual objects and/or other portions of the virtual environment for display as the view 130-A shifts to view 130-B.

In some cases, the extended reality system 100 may provide various types of virtual experiences, such as a three-dimensional (3D) gaming experiences, social media experiences, collaborative virtual environment for a group of users (e.g., including the user 110), among others. While some examples provided herein apply to 3D collaborative virtual environments, the systems and techniques described herein apply to any type of virtual environment or experience in which a virtual representation (or avatar) can be used to represent a user or participant of the virtual environment/experience.

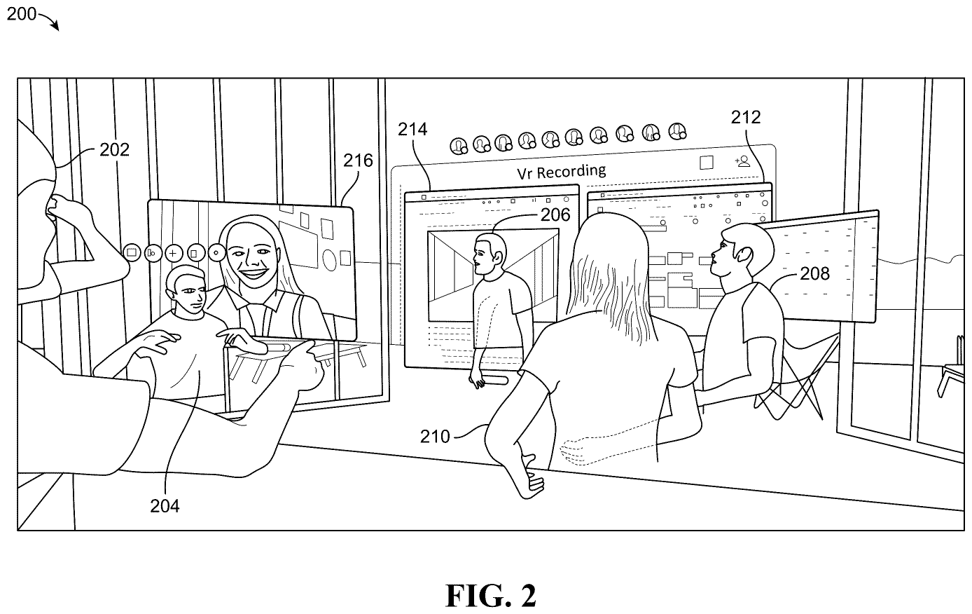

FIG. 2 is a diagram illustrating an example of a virtual environment 200 in which various users interact with one another in a virtual session via virtual representations (or avatars) of the users in the virtual environment 200. The virtual representations include including a virtual representation 202 of a first user, a virtual representation 204 of a second user, a virtual representation 206 of a third user, a virtual representation 208 of a fourth user, and a virtual representation 210 of a fifth user. Other background information of the virtual environment 200 is also shown, including a virtual calendar 212, a virtual web page 214, and a virtual video conference interface 216. The users may visually, audibly, haptically, or otherwise experience the virtual environment from each user's perspective while interacting with the virtual representations of the other users. For example, the virtual environment 200 is shown from the perspective of the first user (represented by the virtual representation 202).

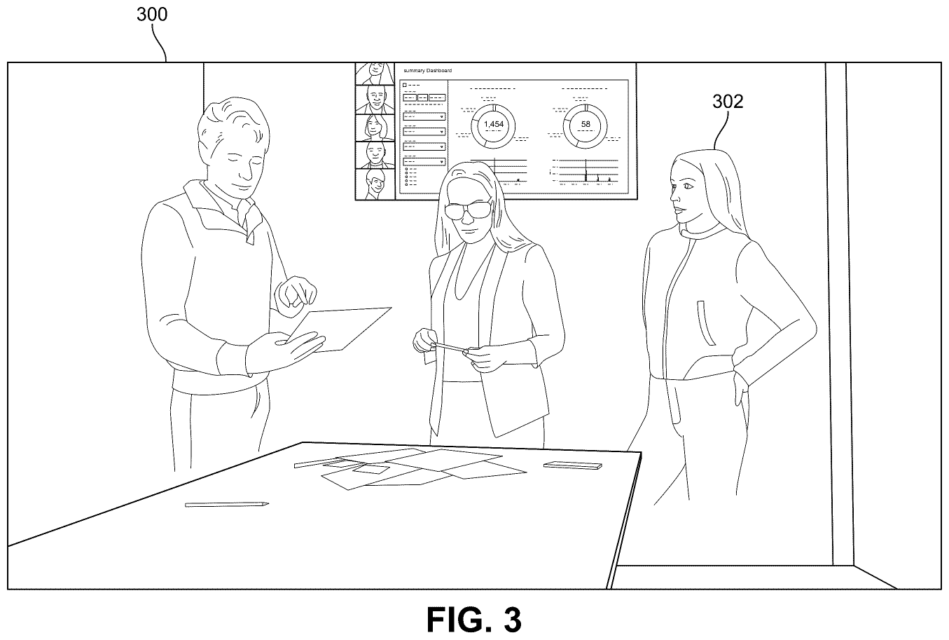

FIG. 3 is an image 300 illustrating an example of virtual representations of various users, including a virtual representation 302 of one of the users. For instance, the virtual representation 302 may be used in the 3D collaborative virtual environment 200 of FIG. 2.

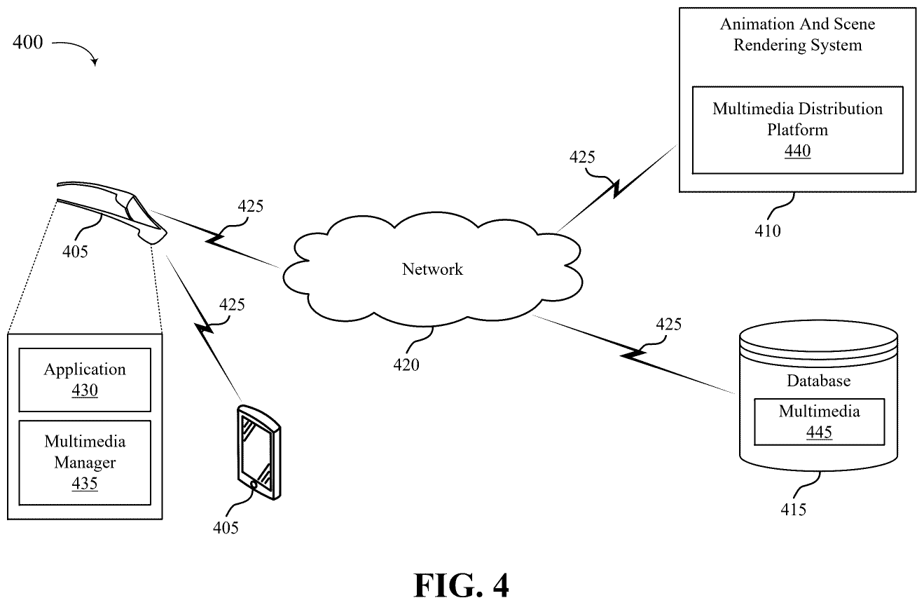

FIG. 4 is a diagram illustrating an example of a system 400 that can be used to perform the systems and techniques described herein, in accordance with aspects of the present disclosure. As shown, the system 400 includes client devices 405, an animation and scene rendering system 410, and storage 415. Although the system 400 illustrates two devices 405, a single animation and scene rendering system 410, storage 415, and network 420, the present disclosure applies to any system architecture having one or more devices 405, animation and scene rendering system 410, storage 415, and network 420. In some cases, the storage 415 may be part of the animation and scene rendering system 410. The devices 405, the animation and scene rendering system 410, and the storage 415 may communicate with each other and exchange information that supports generation of virtual content for XR, such as multimedia packets, multimedia data, multimedia control information, pose prediction parameters, via network 420 using communication links 425. In some cases, a portion of the techniques described herein for providing distributed generation of virtual content may be performed by one or more of the devices 405 and a portion of the techniques may be performed by the animation and scene rendering system 410, or both.

A device 405 may be an XR device (e.g., a head-mounted display (HMD), XR glasses such as virtual reality (VR) glasses, augmented reality (AR) glasses, etc.), a mobile device (e.g., a cellular phone, a smartphone, a personal digital assistant (PDA), etc.), a wireless communication device, a tablet computer, a laptop computer, and/or other device that supports various types of communication and functional features related to multimedia (e.g., transmitting, receiving, broadcasting, streaming, sinking, capturing, storing, and recording multimedia data). A device 405 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 405 may also be able to communicate directly with another device (e.g., using a peer-to-peer (P2P) or device-to-device (D2D) protocol, such as using sidelink communications). For example, a device 405 may be able to receive from or transmit to another device 405 variety of information, such as instructions or commands (e.g., multimedia-related information).

The devices 405 may include an application 430 and a multimedia manager 435. While the system 400 illustrates the devices 405 including both the application 430 and the multimedia manager 435, the application 430 and the multimedia manager 435 may be an optional feature for the devices 405. In some cases, the application 430 may be a multimedia-based application that can receive (e.g., download, stream, broadcast) from the animation and scene rendering system 410, storage 415 or another device 405, or transmit (e.g., upload) multimedia data to the animation and scene rendering system 410, the storage 415, or to another device 405 via using communication links 425.

The multimedia manager 435 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 435 may process multimedia (e.g., image data, video data, audio data) from and/or write multimedia data to a local memory of the device 405 or to the storage 415.

The multimedia manager 435 may also be configured to provide multimedia enhancements, multimedia restoration, multimedia analysis, multimedia compression, multimedia streaming, and multimedia synthesis, among other functionality. For example, the multimedia manager 435 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 435 may process multimedia data to support server-based pose prediction for XR, according to the techniques described herein.

The animation and scene rendering system 410 may be a server device, such as a data server, a cloud server, a server associated with a multimedia subscription provider, proxy server, web server, application server, communications server, home server, mobile server, edge or cloud-based server, a personal computer acting as a server device, a mobile device such as a mobile phone acting as a server device, an XR device acting as a server device, a network router, any combination thereof, or other server device. The animation and scene rendering system 410 may in some cases include a multimedia distribution platform 440. In some cases, the multimedia distribution platform 440 may be a separate device or system from the animation and scene rendering system 410. The multimedia distribution platform 440 may allow the devices 405 to discover, browse, share, and download multimedia via network 420 using communication links 425, and therefore provide a digital distribution of the multimedia from the multimedia distribution platform 440. As such, a digital distribution may be a form of delivering media content such as audio, video, images, without the use of physical media but over online delivery mediums, such as the Internet. For example, the devices 405 may upload or download multimedia-related applications for streaming, downloading, uploading, processing, enhancing, etc. multimedia (e.g., images, audio, video). The animation and scene rendering system 410 or the multimedia distribution platform 440 may also transmit to the devices 405 a variety of information, such as instructions or commands (e.g., multimedia-related information) to download multimedia-related applications on the device 405.

The storage 415 may store a variety of information, such as instructions or commands (e.g., multimedia-related information). For example, the storage 415 may store multimedia 445, information from devices 405 (e.g., pose information, representation information for virtual representations or avatars of users, such as codes or features related to facial representations, body representations, hand representations, etc., and/or other information). A device 405 and/or the animation and scene rendering system 410 may retrieve the stored data from the storage 415 and/or more send data to the storage 415 via the network 420 using communication links 425. In some examples, the storage 415 may be a memory device (e.g., read only memory (ROM), random access memory (RAM), cache memory, buffer memory, etc.), a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 420 may provide encryption, access authorization, tracking, Internet Protocol (IP) connectivity, and other access, computation, modification, and/or functions. Examples of network 420 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 420 may include the Internet.

The communication links 425 shown in the system 400 may include uplink transmissions from the device 405 to the animation and scene rendering system 410 and the storage 415, and/or downlink transmissions, from the animation and scene rendering system 410 and the storage 415 to the device 405. The communication links 425 may transmit bidirectional communications and/or unidirectional communications. In some examples, the communication links 425 may be a wired connection or a wireless connection, or both. For example, the communication links 425 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

In some aspects, a user of the device 405 (referred to as a first user) may be participating in a virtual session with one or more other users (including a second user of an additional device). In such examples, the animation and scene rendering system 410 may process information received from the device 405 (e.g., received directly from the device 405, received from storage 415, etc.) to generate and/or animate a virtual representation (or avatar) for the first user. The animation and scene rendering system 410 may compose a virtual scene that includes the virtual representation of the user and in some cases background virtual information from a perspective of the second user of the additional device. The animation and scene rendering system 410 may transmit (e.g., via network 120) a frame of the virtual scene to the additional device. Further details regarding such aspects are provided below.

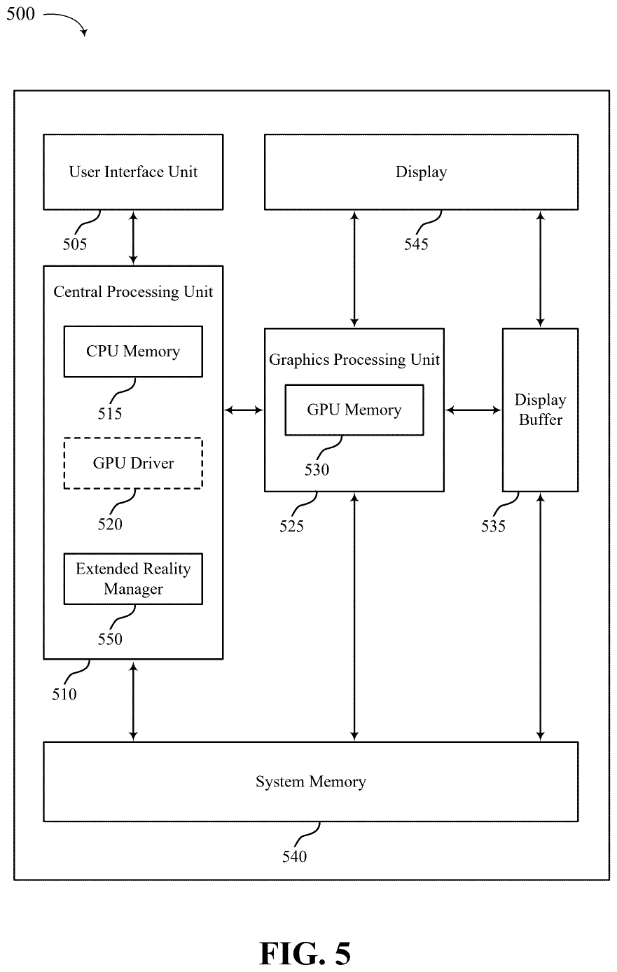

FIG. 5 is a diagram illustrating an example of a device 500. The device 500 can be implemented as a client device (e.g., device 405 of FIG. 4) or as an animation and scene rendering system (e.g., the animation and scene rendering system 410). As shown, the device 500 includes a central processing unit (CPU 510) having CPU memory 515, a GPU 525 having GPU memory 530, a display 545, a display buffer 535 storing data associated with rendering, a user interface unit 505, and a system memory 540. For example, system memory 540 may store a GPU driver 520 (illustrated as being contained within CPU 510 as described below) having a compiler, a GPU program, a locally-compiled GPU program, and the like. User interface unit 505, CPU 510, GPU 525, system memory 540, display 545, and extended reality manager 550 may communicate with each other (e.g., using a system bus).

Examples of CPU 510 include, but are not limited to, a digital signal processor (DSP), general purpose microprocessor, application specific integrated circuit (ASIC), field programmable logic array (FPGA), or other equivalent integrated or discrete logic circuitry. Although CPU 510 and GPU 525 are illustrated as separate units in the example of FIG. 5, in some examples, CPU 510 and GPU 525 may be integrated into a single unit. CPU 510 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 545. As illustrated, CPU 510 may include CPU memory 515. For example, CPU memory 515 may represent on-chip storage or memory used in executing machine or object code. CPU memory 515 may include one or more volatile or non-volatile memories or storage devices, such as flash memory, a magnetic data media, an optical storage media, etc. CPU 510 may be able to read values from or write values to CPU memory 515 more quickly than reading values from or writing values to system memory 540, which may be accessed, e.g., over a system bus.

GPU 525 may represent one or more dedicated processors for performing graphical operations. For example, GPU 525 may be a dedicated hardware unit having fixed function and programmable components for rendering graphics and executing GPU applications. GPU 525 may also include a DSP, a general purpose microprocessor, an ASIC, an FPGA, or other equivalent integrated or discrete logic circuitry. GPU 525 may be built with a highly-parallel structure that provides more efficient processing of complex graphic-related operations than CPU 510. For example, GPU 525 may include a plurality of processing elements that are configured to operate on multiple vertices or pixels in a parallel manner. The highly parallel nature of GPU 525 may allow GPU 525 to generate graphic images (e.g., graphical user interfaces and two-dimensional or three-dimensional graphics scenes) for display 545 more quickly than CPU 510.

GPU 525 may, in some instances, be integrated into a motherboard of device 500. In other instances, GPU 525 may be present on a graphics card or other device or component that is installed in a port in the motherboard of device 500 or may be otherwise incorporated within a peripheral device configured to interoperate with device 500. As illustrated, GPU 525 may include GPU memory 530. For example, GPU memory 530 may represent on-chip storage or memory used in executing machine or object code. GPU memory 530 may include one or more volatile or non-volatile memories or storage devices, such as flash memory, a magnetic data media, an optical storage media, etc. GPU 525 may be able to read values from or write values to GPU memory 530 more quickly than reading values from or writing values to system memory 540, which may be accessed, e.g., over a system bus. That is, GPU 525 may read data from and write data to GPU memory 530 without using the system bus to access off-chip memory. This operation may allow GPU 525 to operate in a more efficient manner by reducing the need for GPU 525 to read and write data via the system bus, which may experience heavy bus traffic.

Display 545 represents a unit capable of displaying video, images, text or any other type of data for consumption by a viewer. In some cases, such as when the device 500 is implemented as an animation and scene rendering system, the device 500 may not include the display 545. The display 545 may include a liquid-crystal display (LCD), a light emitting diode (LED) display, an organic LED (OLED), an active-matrix OLED (AMOLED), or the like. Display buffer 535 represents a memory or storage device dedicated to storing data for presentation of imagery, such as computer-generated graphics, still images, video frames, or the like for display 545. Display buffer 535 may represent a two-dimensional buffer that includes a plurality of storage locations. The number of storage locations within display buffer 535 may, in some cases, generally correspond to the number of pixels to be displayed on display 545. For example, if display 545 is configured to include 640×480 pixels, display buffer 535 may include 640×480 storage locations storing pixel color and intensity information, such as red, green, and blue pixel values, or other color values. Display buffer 535 may store the final pixel values for each of the pixels processed by GPU 525. Display 545 may retrieve the final pixel values from display buffer 535 and display the final image based on the pixel values stored in display buffer 535.

User interface unit 505 represents a unit with which a user may interact with or otherwise interface to communicate with other units of device 500, such as CPU 510. Examples of user interface unit 505 include, but are not limited to, a trackball, a mouse, a keyboard, and other types of input devices. User interface unit 505 may also be, or include, a touch screen and the touch screen may be incorporated as part of display 545.

System memory 540 may include one or more computer-readable storage media. Examples of system memory 540 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 540 may store program modules and/or instructions that are accessible for execution by CPU 510. Additionally, system memory 540 may store user applications and application surface data associated with the applications. System memory 540 may in some cases store information for use by and/or information generated by other components of device 500. For example, system memory 540 may act as a device memory for GPU 525 and may store data to be operated on by GPU 555 as well as data resulting from operations performed by GPU 525.

In some examples, system memory 540 may include instructions that cause CPU 510 or GPU 525 to perform the functions ascribed to CPU 510 or GPU 525 in aspects of the present disclosure. System memory 540 may, in some examples, be considered as a non-transitory storage medium. The term “non-transitory” should not be interpreted to mean that system memory 540 is non-movable. As one example, system memory 540 may be removed from device 500 and moved to another device. As another example, a system memory substantially similar to system memory 540 may be inserted into device 500. In certain examples, a non-transitory storage medium may store data that can, over time, change (e.g., in RAM).

System memory 540 may store a GPU driver 520 and compiler, a GPU program, and a locally-compiled GPU program. The GPU driver 520 may represent a computer program or executable code that provides an interface to access GPU 525. CPU 510 may execute the GPU driver 520 or portions thereof to interface with GPU 525 and, for this reason, GPU driver 520 is shown in the example of FIG. 5 within CPU 510. GPU driver 520 may be accessible to programs or other executables executed by CPU 510, including the GPU program stored in system memory 540. Thus, when one of the software applications executing on CPU 510 requires graphics processing, CPU 510 may provide graphics commands and graphics data to GPU 525 for rendering to display 545 (e.g., via GPU driver 520).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 525 to execute commands without user knowledge as to the specifics of the hardware components. In order to process the graphics rendering instructions, CPU 510 may issue one or more rendering commands to GPU 525 (e.g., through GPU driver 520) to cause GPU 525 to perform some or all of the rendering of the graphics data. In some examples, the graphics data to be rendered may include a list of graphics primitives (e.g., points, lines, triangles, quadrilaterals, etc.).

The GPU program stored in system memory 540 may invoke or otherwise include one or more functions provided by GPU driver 520. CPU 510 generally executes the program in which the GPU program is embedded and, upon encountering the GPU program, passes the GPU program to GPU driver 520. CPU 510 executes GPU driver 520 in this context to process the GPU program. That is, for example, GPU driver 520 may process the GPU program by compiling the GPU program into object or machine code executable by GPU 525. This object code may be referred to as a locally-compiled GPU program. In some examples, a compiler associated with GPU driver 520 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 510 and GPU 525).

In the example of FIG. 5, the compiler may receive the GPU program from CPU 510 when executing HL code that includes the GPU program. That is, a software application being executed by CPU 510 may invoke GPU driver 520 (e.g., via a graphics API) to issue one or more commands to GPU 525 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 525 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 520 may formulate one or more commands that specify one or more operations for GPU 525 to perform in order to render the primitive. When GPU 525 receives a command from CPU 510, it may decode the command and configure one or more processing elements to perform the specified operation and may output the rendered data to display buffer 535.

GPU 525 may receive the locally-compiled GPU program, and then, in some instances, GPU 525 renders one or more images and outputs the rendered images to display buffer 535. For example, GPU 525 may generate a number of primitives to be displayed at display 545. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 525 for display as an image (or frame in the context of video data) via display 545. GPU 525 may transform primitives and other attributes (e.g., that define a color, texture, lighting, camera configuration, or other aspect) of the primitives into a so-called “world space” by applying one or more model transforms (which may also be specified in the state data). Once transformed, GPU 525 may apply a view transform for the active camera (which again may also be specified in the state data defining the camera) to transform the coordinates of the primitives and lights into the camera or eye space. GPU 525 may also perform vertex shading to render the appearance of the primitives in view of any active lights. GPU 525 may perform vertex shading in one or more of the above model, world, or view space.

Once the primitives are shaded, GPU 525 may perform projections to project the image into a canonical view volume. After transforming the model from the eye space to the canonical view volume, GPU 525 may perform clipping to remove any primitives that do not at least partially reside within the canonical view volume. For example, GPU 525 may remove any primitives that are not within the frame of the camera. GPU 525 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 525 may then rasterize the primitives. Generally, rasterization may refer to the task of taking an image described in a vector graphics format and converting it to a raster image (e.g., a pixelated image) for output on a video display or for storage in a bitmap file format.

A GPU 525 may include a dedicated fast bin buffer (e.g., a fast memory buffer, such as GMEM, which may be referred to by GPU memory 530). As discussed herein, a rendering surface may be divided into bins. In some cases, the bin size is determined by format (e.g., pixel color and depth information) and render target resolution divided by the total amount of GMEM. The number of bins may vary based on device 500 hardware, target resolution size, and target display format. A rendering pass may draw (e.g., render, write, etc.) pixels into GMEM (e.g., with a high bandwidth that matches the capabilities of the GPU). The GPU 525 may then resolve the GMEM (e.g., burst write blended pixel values from the GMEM, as a single layer, to a display buffer 535 or a frame buffer in system memory 540). Such may be referred to as bin-based or tile-based rendering. When all bins are complete, the driver may swap buffers and start the binning process again for a next frame.

For example, GPU 525 may implement a tile-based architecture that renders an image or rendering target by breaking the image into multiple portions, referred to as tiles or bins. The bins may be sized based on the size of GPU memory 530 (e.g., which may alternatively be referred to herein as GMEM or a cache), the resolution of display 545, the color or Z precision of the render target, etc. When implementing tile-based rendering, GPU 525 may perform a binning pass and one or more rendering passes. For example, with respect to the binning pass, GPU 525 may process an entire image and sort rasterized primitives into bins.

The device 500 may use sensor data, sensor statistics, or other data from one or more sensors. Some examples of the monitored sensors may include IMUs, eye trackers, tremor sensors, heart rate sensors, etc. In some cases, an IMU may be included in the device 500, and may measure and report a body's specific force, angular rate, and sometimes the orientation of the body, using some combination of accelerometers, gyroscopes, or magnetometers.

As shown, device 500 may include an extended reality manager 550. The extended reality manager 550 may implement aspects of extended reality, augmented reality, virtual reality, etc. In some cases, such as when the device 500 is implemented as a client device (e.g., device 405 of FIG. 4), the extended reality manager 550 may determine information associated with a user of the device and/or a physical environment in which the device 500 is located, such as facial information, body information, hand information, device pose information, audio information, etc. The device 500 may transmit the information to an animation and scene rendering system (e.g., animation and scene rendering system 410). In some cases, such as when the device 500 is implemented as an animation and scene rendering system (e.g., the animation and scene rendering system 410 of FIG. 4), the extended reality manager 550 may process the information provided by a client device as input information to generate and/or animate a virtual representation for a user of the client device.

Virtual representations (e.g., avatars) are an important component of virtual environments. A virtual representation (or avatar) is a 3D representation of a user and allows the user to interact with the virtual scene As noted previously, there are different ways to represent a virtual representation of a user (e.g., an avatar) and corresponding animation data. For example, avatars may be purely synthetic or may be an accurate representation of the user (e.g., as shown by the virtual representation 302 shown in the image of FIG. 3). A virtual representation (or avatar) may need to be real-time captured or retargeted to reflect the user's actual motion, body pose, facial expression, etc. Because of the many ways to represent an avatar and corresponding animation data, it can be difficult to integrate every single variant of these representations into a scene description.

As noted previously, systems and techniques are described herein for described herein for providing virtual representation (e.g., avatar) encoding in scene descriptions. As described herein, the systems and techniques can decouple the representation of a virtual representation (or avatar) and its animation data from the avatar integration in the scene description. For instance, the systems and techniques can perform virtual representation (or avatar) reconstruction to generate a dynamic mesh that represents a virtual representation (or avatar) of a user, which can allow the systems and techniques to deconstruct the virtual representation (or avatar) into multiple mesh nodes. Each mesh node can correspond to a body part of the virtual representation (or avatar). The multiple mesh nodes enable an XR system to support interactivity with various parts of a virtual representation (e.g., with hands of the avatar).

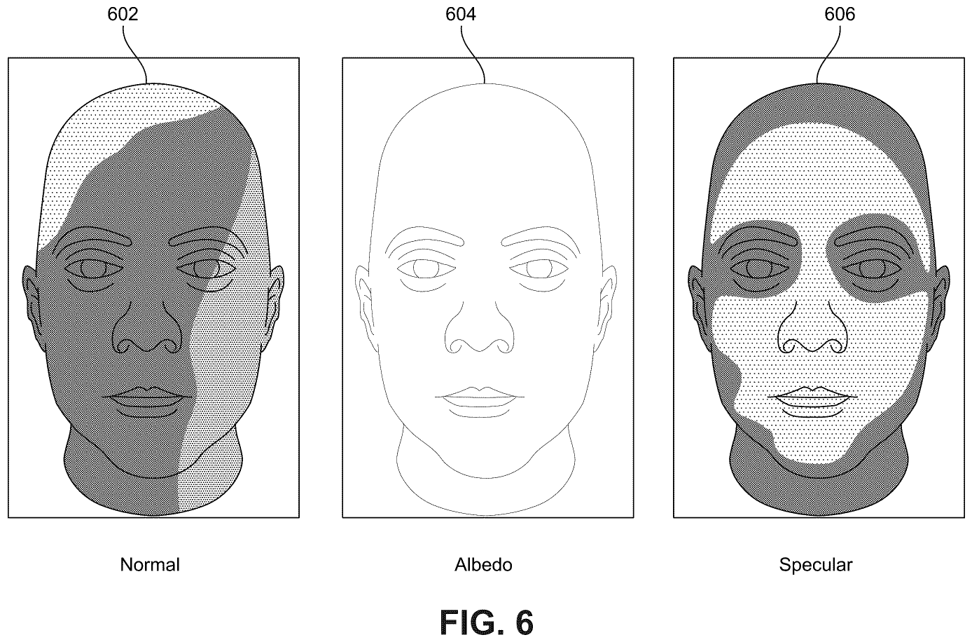

Various animation assets may be needed to model an avatar, including a mesh (e.g., a 3D mesh, such as a triangle mesh, including a plurality of vertices and line segments connected the vertices), a diffuse or albedo texture, normals specular reflection texture, and in some cases other types of textures. These various assets may be available from enrollment or offline reconstruction. FIG. 6 is a diagram illustrating an example of a normal map 602, an albedo map 604, and a specular reflection map 606.

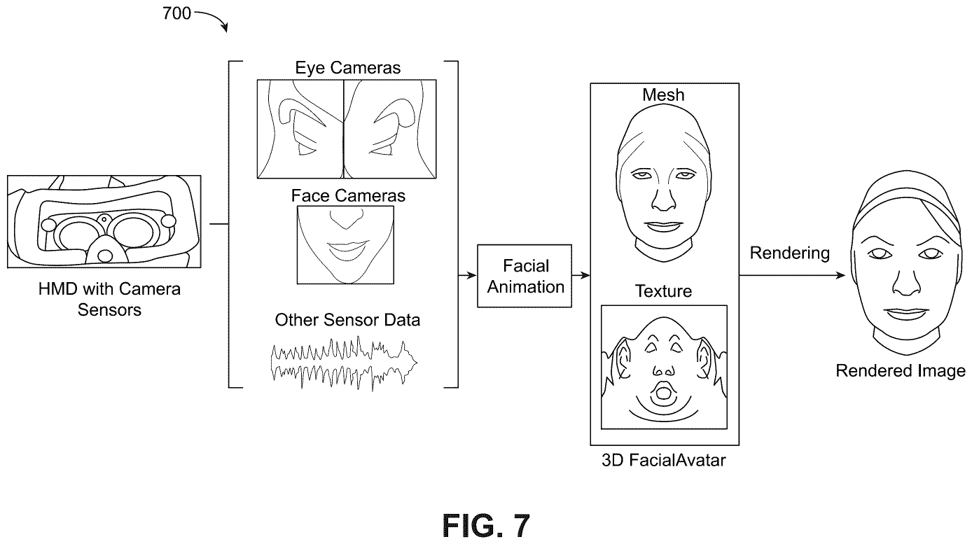

Animation of a virtual representation (e.g., avatar) can be performed using various techniques. FIG. 7 is a diagram 700 illustrating an example of one technique for performing avatar animation. As shown, camera sensors of a head-mounted display (HMD) are used to capture images of a user's face, including eye cameras used to capture images of the user's eyes, face cameras used to capture the visible part of the face (e.g., mouth, chin, cheeks, part of the nose, etc.), and other sensors for capturing other sensor data (e.g., audio, etc.). Facial animation can then be performed to generate a 3D mesh and texture for the 3D facial avatar. The mesh and texture can then be rendered by a rendering engine to generate a rendered image.

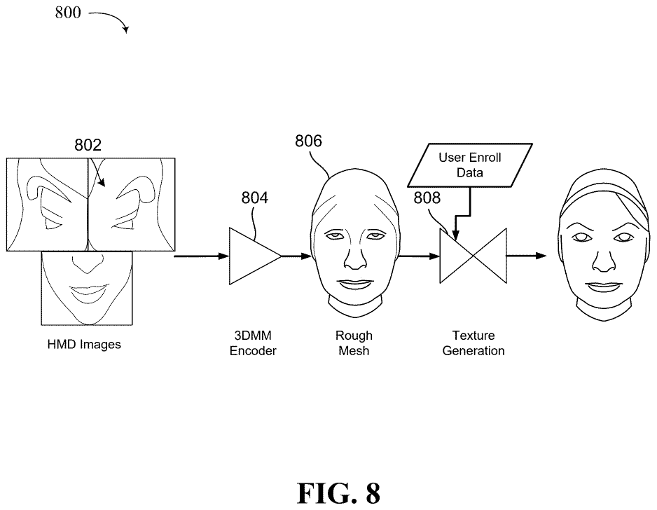

In some cases, facial animation can be performed with or using blend shapes. FIG. 8 is a diagram 800 illustrating an example of performing facial animation with blendshapes. As shown, a system can estimate a rough or course 3D mesh 806 and blend shapes from images 802 (e.g., captured using sensors of an HMD or other XR device) using 3D Morphable Model (3DMM) encoding of a 3DMM encoder 804. The system can generate texture using one or more techniques, such as using a machine learning system 808 (e.g., one or more neural networks) or computer graphics techniques (e.g., Metahumans). In some cases, a system may need to compensate for misalignments due to rough geometry, for example as described in U.S. Non-Provisional application Ser. No. 17/845,884, filed Jun. 21, 2022 and titled “VIEW DEPENDENT THREE-DIMENSIONAL MORPHABLE MODELS,” which is hereby incorporated by reference in its entirety and for all purposes.

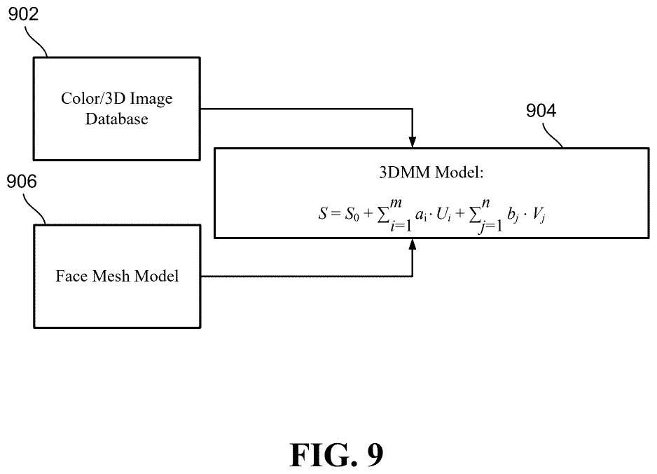

A 3DMM is a 3D face mesh representation of known topology. A 3DMM can be linear or non-linear. FIG. 9 is a diagram illustrating an example of a system 900 that can generate a 3DMM face model or mesh 904. The system 900 can obtain a dataset of 3D and/or color images for various persons (and in some cases grayscale images) from a database 902. The system 900 can also obtain known mesh topologies of face mesh models 906 corresponding to the faces of the images in the database 902. In some cases, Principal Component Analysis (PCA) can be used to find a representation of identifiers (IDs)/expressions in case of linear representations. Expressions can also be modeled via blend shapes (e.g., meshes) at various states or expressions. Using these parameters, the system can manipulate or steer the mesh. The 3DMM can be generated as follows:

$$S = {S}_{0} + {\sum }_{i = 1}^{m} {a}_{i} \cdot {U}_{i} + {\sum }_{j + 1}^{n} {b}_{j} \cdot {V}_{j}$$

The output can include the mean Shape S₀, a shape parameter aᵢ, a shape basis Uᵢ, an expression parameter bⱼ, and an expression basis or blend shape Vⱼ.

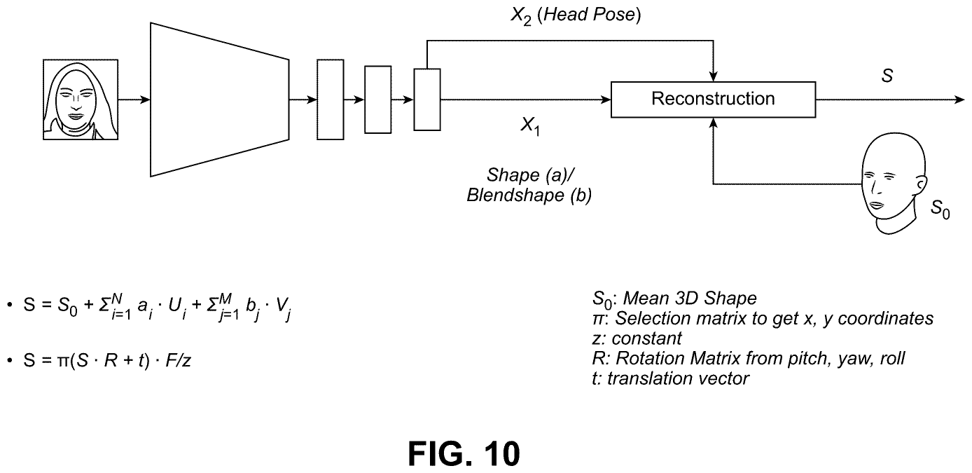

In some cases, blend shapes can be determined using 3DMM encoding. The blend shapes can then be used to reconstruct a deformed mesh, such as to animate an avatar. For instance, as shown in FIG. 10, animating an avatar can be summarized as determining the weight of each blend shape given an input image. Such a technique is described in U.S. Non-Provisional application Ser. No. 17/384,522, filed Jul. 23, 2021 and titled “ADAPTIVE BOUNDING FOR THREE-DIMENSIONAL MORPHABLE MODELS,” which is hereby incorporated by reference in its entirety and for all purposes. The 3DMM equation S from above is shown in FIG. 10 and provided again below:

$$S = {S}_{0} + {\sum }_{i = 1}^{N} {a}_{i} \cdot {U}_{i} + {\sum }_{j = 1}^{M} {b}_{j} \cdot {V}_{j}$$

and can also be represented as:

$$s = π ( S \cdot R + t ) \cdot F / z$$

where S₀ is a mean 3D shape, π is a selection matrix to obtain the x,y coordinates, z is a constant, R is a rotation matrix from pitch, yaw, roll, and t is a translation vector.

In some cases, facial avatars may be represented as parametrized 3D morphological models (3DMMs). These 3DMM may include shape coefficients and expression coefficients that may be generated by machine learning (ML) models (e.g., neural networks, deep learning models, etc.) that are trained, for example, using near infrared (NIR) images captured at different viewing angles from inward facing cameras of a head mounted display (HMD). In some cases, the training of the ML models may be via supervised learning guided by annotated facial landmarks and contours on 2D images. The training may update the weights and/or biases of the ML model such that the 2D loss between the projected 3D face and the 2D landmarks are minimized. In some cases, accurate projection of the 3D face assumes the availability of an accurate camera pose for each frame captured and this can be difficult to obtain. Where an accurate camera pose not available for each frame, there can be inconsistent projections potentially resulting in inaccurate and unstable outcomes. Additionally, obtaining detailed 2D labels for a large number of images in a consistent way can be challenging and may involve a significant amount of time, effort, and/or cost.

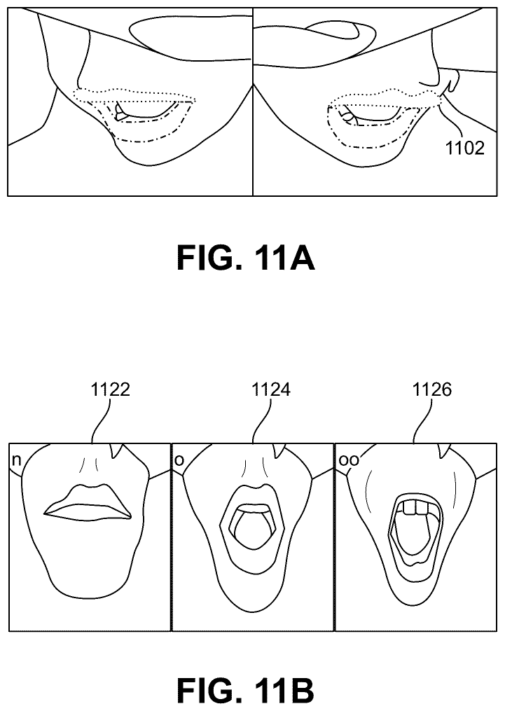

In some cases, a quality of reproducing human expressions using facial avatars may be based on faithfully reproducing a shape of various movable parts of a face, such as eye-lids, eyeballs, mouth, etc. As shown in FIG. 11A, traditionally, the various moveable parts of a face may be annotated using landmarks and contours 1102. In some cases, it may be useful to annotate the positions of these movable parts as broad classes rather than accurate contours 1102 and associate them with specific 3DMM coefficients responsible for those motions. For example, as shown in FIG. 11B, different classes, such as “n,” “o,” and “oo” in this example, may be used to represent how open a particular moveable part, such as a mouth, is. In this example, an image 1122 may be labelled (e.g., classed) with “n” if a person in the image 1122 has a closed mouth, while a second image 1124 may be labelled with an “o” if the person in the second image 1124 has an open mouth, and a third image 1126 may be labelled with an “oo” if a mouth of the person in the third image 1126 is open extremely wide. Thus, while the annotated images may be used to perform a regression task where in a continuous domain (e.g., between a mouth that is closed and a mouth that is wide open), classification operates in a quantized domain with non-overlapping classes, making classification a generally easier task to perform.

In some cases, finetuning a regression network using a classification-based loss may be used. Classification style finetuning can be done with less effort, time, and/or cost as compared to, for example, using calibrated camera systems and numerous annotators to label training data. Classification style finetuning may work even if wide variety of expressions are not available. In some cases, a classify to regress framework may be used with training data and real world data to perform classification and a range-quantization loss function that buckets the parameter space into smaller chunks to leverage minimal and sparse classifications may be used.

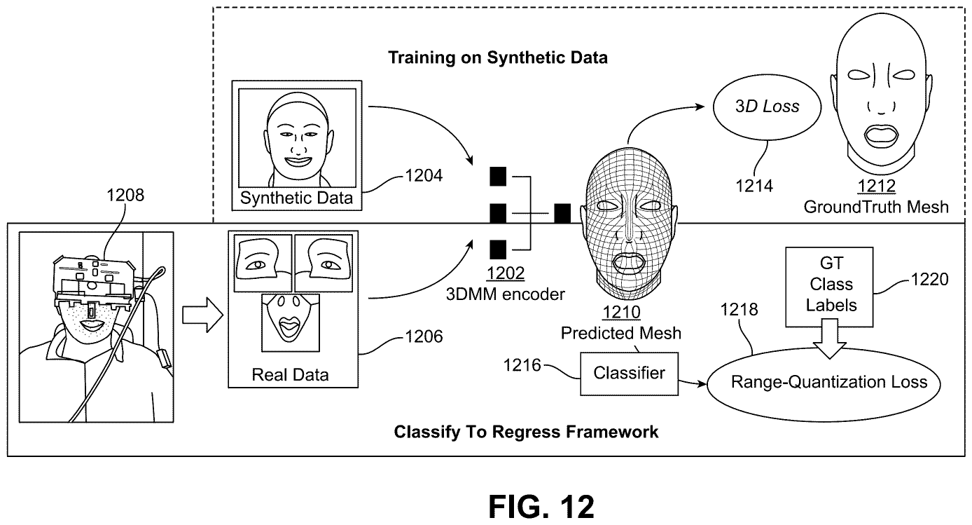

FIG. 12 is a diagram illustrating how a classify to regress framework may be used 1200, in accordance with aspects of the present disclosure. In some cases, a classify to regress framework may be used in conjunction with a 3DMM encoder 1202. In some cases, the classify to regress framework may use a classification-based loss, and the classify to regress framework may be used to fine-tune a pre-trained 3DMM encoder 1202. In other cases, the classify to regress framework may be used to finetune or train a partially trained, or untrained (e.g., with randomly initialized weights), 3DMM encoder 1202.

In some cases, the 3DMM encoder 1202 may be trained using either (or both) synthetic data 1204 and/or real data 1206. In some cases, the synthetic data 1204 may be generated images. The real data 1206 may be data captured, for example, using an HMD 1208. The 3DMM encoder 1202 may generate a set of parameters (e.g., as a matrix or vector) that describe a predicted mesh representation 1210 of an avatar that may be used to represent a user. The predicted mesh representation 1210 may have an expression corresponding to an expression of the user. In some cases, a decoder may use the set of parameters to generate the predicted mesh representation 1210. In traditional training for the 3DMM encoder 1202, the predicted mesh representation 1210 may be compared to a ground truth mesh 1212 (e.g., which may have been used to generate the synthetic data 1204) to determine a loss 1214.

In some cases, the classify to regress framework may include a classifier 1216 and a determination of a range-quantization loss 1218 using ground truth class labels 1220. As will be described below, the classifier 1216 may receive the set of parameters and/or predicted mesh representation 1210 and classify the expression into one or more buckets (e.g., based on expression(s) selected for finetuning). The range-quantization loss 1218 may be determined based on the classified expression and the ground truth class labels 1220.

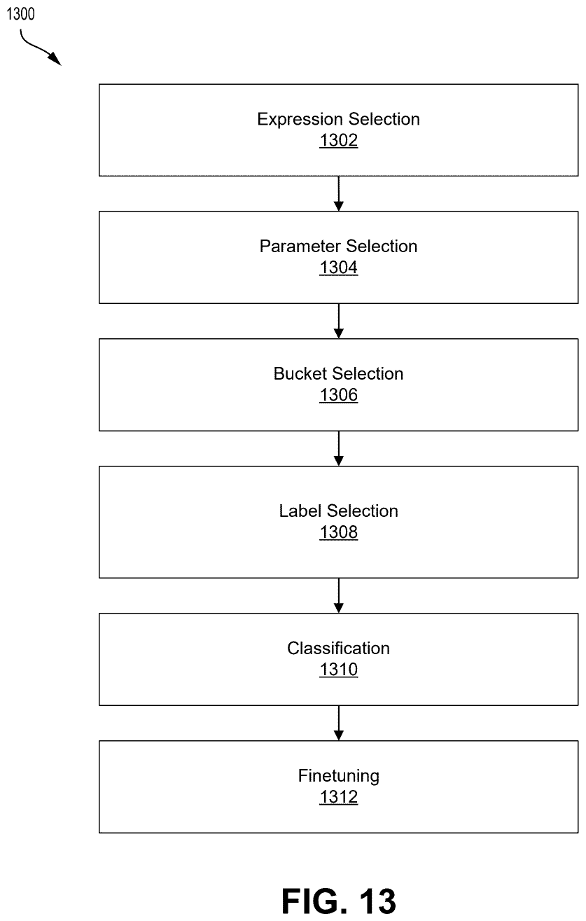

FIG. 13 is a flow diagram illustrating operations of a classify to regress framework 1300, in accordance with aspects of the present disclosure. At block 1302, expression selection may be performed. For example, one or more specific expressions, such as movement of the eyeball, movement of the eyebrows, mouth movement, how open/closed an eye is, some combination thereof, etc. may be selected for finetuning. In some cases, the expression(s) selected for finetuning may be selected manually. In other cases, expression(s) may be selected for finetuning in an automated way. For example, each expression supported by the 3DMM encoder 1202 and/or classifier 1216 may be finetuned in turn.

At block 1304, parameter selection may be performed. Parameter selection may identify the parameters (e.g., coefficients, vector/matrix values, etc.) output by the 3DMM encoder corresponding to a facial element and/or the expression(s) selected for finetuning. For example, a 3DMM encoder may output a set of parameters and certain parameter(s), such as parameter 270, may be identified as a parameter responsible (e.g., indicating, controlling, etc.) for shape/morphology of a facial element, such as how closed an eye is, the shape of a mouth, how open the mouth is, etc. In some cases, parameter selection may be performed manually or automatically based on, for example, examining how the 3DMM is configured to generate the parameters/predicated mesh representation 1210, tracing how various parameters influence the generation of the predicted mesh representation 1210, and the like.

At block 1306, bucket selection may be performed. For bucket selection, ranges of the identified parameter may be identified to bucket (e.g., divide) the full range of the identified parameter (e.g., 0-1) into smaller chunks. For example, the range of the parameter describing how closed an eye is may be divided into five buckets where each bucket is associated with a lower bound and an upper bound (e.g., 0-0.2) describing the range of the bucket within the full range of the identified parameter associated with a particular expression or behavior. For example, parameters associated with an eye may be divided into a range of buckets indicating how open/closed the eye is, such as fully open, neutrally open, slightly closed, etc. Similarly, parameters associated with an eyebrow may be divided into multiple buckets indicating how raised/arched an eyebrow is, such as fully raised/arched, partially raised/arched, neutral, etc. In some cases, the range of the bucket may be determined based on how the 3DMM face model appears within the range. For example, the 3DMM may be rendered with a certain range of parameter values and, for example, if the rendered 3DMMs include a left eye that appears half-closed within the certain range of parameter values, then that range of parameter values may be bucketed together. Determining which bucket a rendered facial element, for a particular parameter value, falls into may be manually performed. In some examples, certain expressions may be associated with multiple parameters and each parameter of the multiple parameters may have their own ranges.

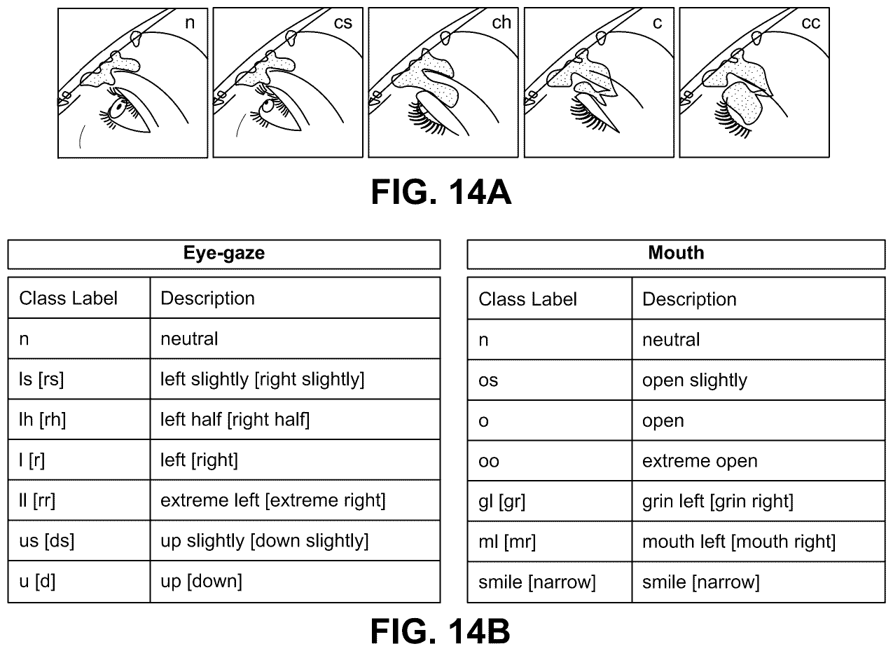

At block 1308, labels may be selected. For example, class labels may be identified/selected for the buckets. Returning to the example of the five buckets for the parameter describing how closed an eye is, the buckets may be assigned a label such as a “n” bucket for neutral, “cs” for slightly closed, “ch” for halfway closed, “c” for closed, and “cc” for completely closed or squeezed shut, as shown in FIG. 14A. In some examples, label selection may be performed manually. In other cases, label selection may be automated. Labels may be arbitrary and/or may be omitted. The labels may be for convenience, for example for manually categorizing a particular morphology of a facial element of the 3DMM into a bucket. In some cases, parameter selection, bucket selection, and label selection may be performed one-time for a particular expression, domain, and/or 3DMM. FIG. 14B illustrates additional examples of labels for buckets for other parameters. The selected expressions, parameters, buckets, and labels may be passed to a classifier (e.g., classifier 1216 of FIG. 12) for classification.

Returning to FIG. 13, at block 1310, classification may be performed. In some cases, classification may be performed by obtaining real data (e.g., real data 1206 of FIG. 12), and classifying the real data by determining which bucket(s) corresponding expressions shown in the real data fall into. For example, the real data 1206 may be passed into the 3DMM encoder 1202 to generate a set of parameters for generating the predicted mesh representation 1210 and a classifier, such as classifier 1216 of FIG. 12, may determine which bucket the value of one or more of parameters of the predicted mesh representation 1210 fall into.

At block 1312, finetuning (or training) may be performed. Finetuning (or training) may be performed by determining a range-quantization loss (e.g., range-quantization loss 1218 of FIG. 12) and adjusting the 3DMM encoder 1202 based on the determined range-quantization loss.

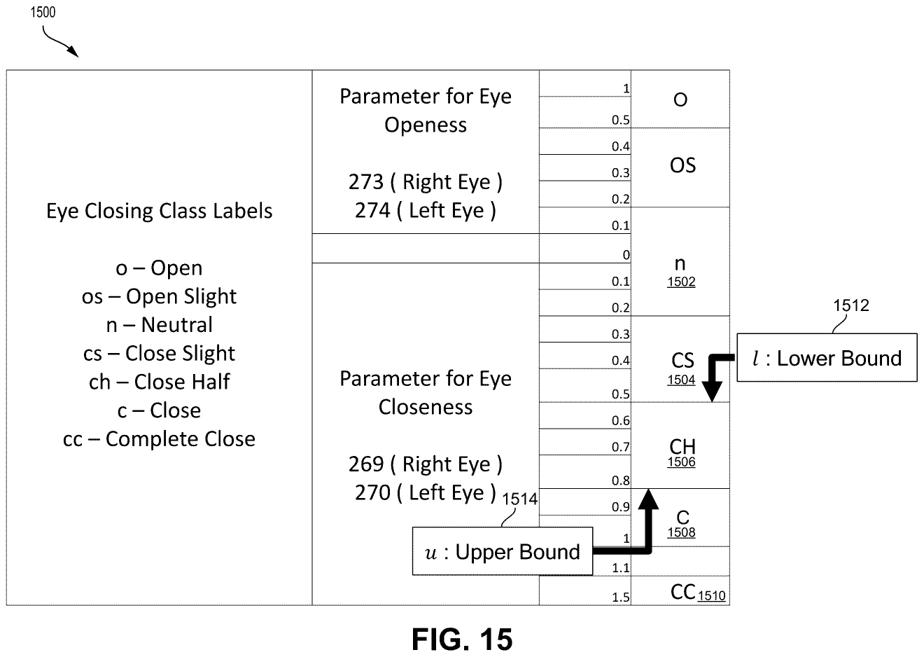

FIG. 15 illustrates class buckets, labels, and ranges 1500 for parameters of a set of parameters, in accordance with aspects of the present disclosure. As an example, an expression for eyes open and eyes closed may be selected along with the corresponding parameters, such as parameter 273 for openness of the right eye and parameter 269 for closeness of the right eye, parameter 274 for openness of the left eye, and parameter 270 for closeness of the left eye. As shown, the parameters may have a full range (e.g., the range of the selected parameters may be the same as for other parameters), such as 0-1.5 for parameters 269 and 270, and 0-1 for parameters 273 and 274. The full range of a parameter may be divided into buckets and labels assigned. For example, the full range of parameters 269 and 270 may be divided into 5 labeled buckets such as a “n” bucket 1502, a “cs” bucket 1504, a “ch” bucket 1506, a “c” bucket 1508, and a “cc” bucket 1510. Each bucket may have a lower bound value 1512 and an upper bound value 1514. For example, the “ch” bucket may have a lower bound value 1512 of 0.6 and an upper bound value 1514 of 0.8. If a 3DMM encoder, such as 3DMM encoder 1202, outputs a set of parameters for an input image where parameter 270 has a value of 0.7, then the input image may be labelled (e.g., placed in the corresponding bucket) as being in the CH bucket. While FIG. 15 illustrates non-overlapping buckets, in some cases, the buckets may be overlapping. In such cases, an image may receive multiple labels based on the overlapping buckets.

In some cases, a classification loss may be determined by comparing the labelled bucket predicted for an image with a ground truth label (e.g., an expected bucket). The labelled bucket represents a classification with quantized loss (e.g., a range of parameter values, but not the exact parameter value), but training the 3DMM encoder may be performed based on a regression loss (e.g., over a continuous domain with an exact value).

In some cases, a new loss function which regresses the expression parameters may be used, such as a range quantization loss function. In some cases, the range quantization loss function may be expressed as:

$$range quantization loss = [ ( x - \frac{u + l}{2} ) \cdot abs - \frac{u - l}{2} ] \cdot relu ,$$

where x represents regressed parameters, u represents an upper bound of the bucket, l represents a lower bound of the bucket, abs represents an absolute function, and relu represents a rectified linear unit. In some cases, the range quantization loss avoids penalizing the 3DMM encoder where the predicted bucket corresponds to the ground truth bucket and penalizes the 3DMM encoder to a degree that the predicted bucket is outside of the ground truth bucket.

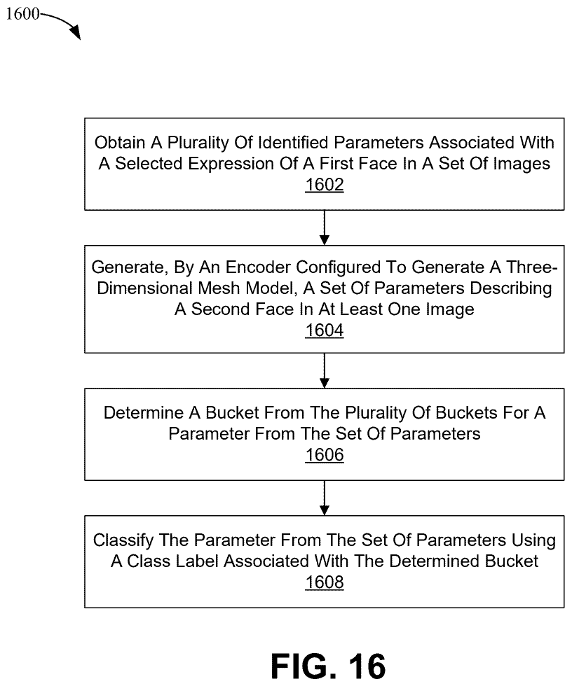

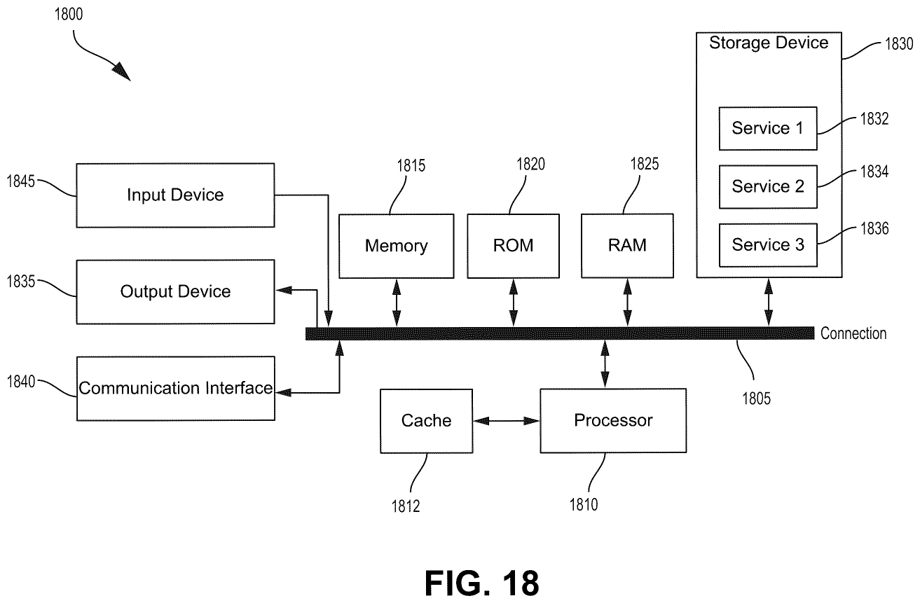

FIG. 16 is a flow diagram illustrating a process 1600 for generating a mesh model, in accordance with aspects of the present disclosure. The process 1600 may be performed by a computing device (or apparatus) or a component (e.g., a chipset, codec, etc.) of the computing device, such as CPU 510 and/or GPU 525 of FIG. 5, and/or processor 1810 of FIG. 18. The computing device may be an animation and scene rendering system (e.g., an edge or cloud-based server, a personal computer acting as a server device, a mobile device such as a mobile phone acting as a server device, an XR device acting as a server device, a network router, or other device acting as a server or other device). The operations of the process 1600 may be implemented as software components that are executed and run on one or more processors (e.g., CPU 510 and/or GPU 525 of FIG. 5, and/or processor 1810 of FIG. 18).

At block 1602, the computing device (or component thereof) may obtain a plurality of identified parameters associated with a selected expression of a first face in a set of images. Parameter selection may identify the parameters (e.g., coefficients, vector/matrix values, etc.) output by the 3DMM encoder corresponding to the expression(s) selected for finetuning. In some cases, a range of the identified plurality of parameters is divided into a plurality of buckets. For bucket selection, ranges of the identified parameter may be identified to bucket (e.g., divide) the full range of the identified parameter (e.g., 0-1) into smaller chunks. In some examples, each bucket of the plurality of buckets is associated with a respective class label. For example, class labels may be identified/selected for the buckets.

At block 1604, the computing device (or component thereof) may generate, by an encoder (e.g., 3DMM encoder 1202 of FIG. 12) configured to generate a three-dimensional mesh model (e.g., predicted mesh representation 1210 of FIG. 12), a set of parameters describing a second face in at least one image. In some examples, the encoder is pre-trained based at least in part on synthetic data.

At block 1606, the computing device (or component thereof) may determine a bucket from the plurality of buckets for a parameter from the set of parameters. In some cases, each bucket is defined based on an upper bound value (e.g., upper bound value 1514 of FIG. 15) for an identified parameter and a lower bound value (e.g., lower bound value 1512 of FIG. 15) for the identified parameter within the range of the plurality of identified parameters.

At block 1608, the computing device (or component thereof) may classify the parameter from the set of parameters using a class label associated with the determined bucket. In some cases, the computing device (or component thereof) may determine a loss between a bucket to which an identified parameter is classified and an expected bucket; and fine-tune parameters of the encoder based on the determined loss.

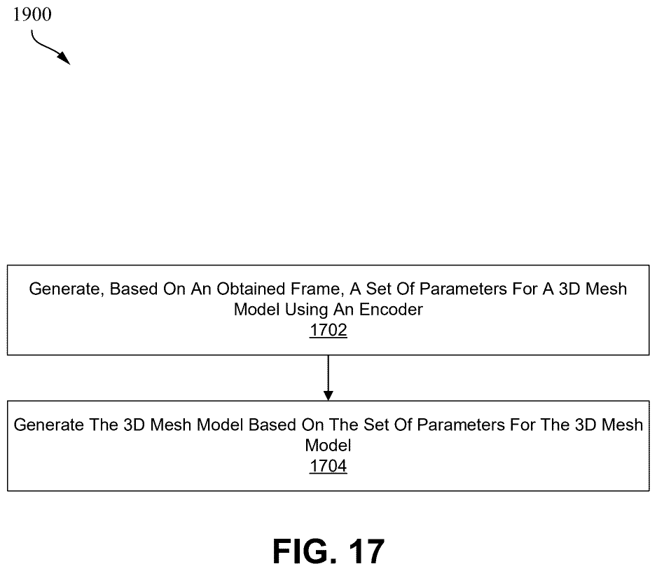

FIG. 17 is a flow diagram illustrating a process 1700 for generating a mesh model, in accordance with aspects of the present disclosure. The process 1700 may be performed by a computing device (or apparatus) or a component (e.g., a chipset, codec, etc.) of the computing device, such as CPU 510 and/or GPU 525 of FIG. 5, and/or processor 1810 of FIG. 18. The computing device may be an animation and scene rendering system (e.g., an edge or cloud-based server, a personal computer acting as a server device, a mobile device such as a mobile phone acting as a server device, an XR device acting as a server device, a network router, or other device acting as a server or other device). The operations of the process 1700 may be implemented as software components that are executed and run on one or more processors (e.g., CPU 510 and/or GPU 525 of FIG. 5, and/or processor 1810 of FIG. 18).

At block 1702, the computing device (or component thereof) may generate, based on an obtained frame, a set of parameters for a three-dimensional (3D) mesh model using an encoder. In some cases, the encoder is trained based on whether a parameter, of the set of parameters, is classified within a bucket. In some examples, the bucket is defined based on an upper bound value for the parameter and a lower bound value for the parameter. In some cases, the encoder is trained further based on a loss determined based on a comparison of the bucket the parameter is classified within and a ground truth bucket for the obtained frame. In some examples, the loss is determined based on the upper bound value for the parameter and the lower bound value for the parameter. In some cases, the upper bound value for the parameter and the lower bound value for the parameter are determined based on an appearance of the 3D mesh model within the upper bound value for the parameter and the lower bound value for the parameter. In some examples, the upper bound value for the parameter and the lower bound value for the parameter are manually determined. In some cases, the computing device (or component thereof) may the select the parameter, of the set of parameters, based on an expression selected for fine-tuning. In some examples, the bucket is assigned a label.

At block 1704, the computing device (or component thereof) may generate the 3D mesh model based on the set of parameters for the 3D mesh model.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 1600, process 1700, and/or other processes described herein may include a processor, microprocessor, micro-computer, or other component of a device that is configured to carry out the steps of the process 1600, process 1700, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1600, process 1700, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1600 and the process 1700 are illustrated as logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1600, process 1700, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 18 is a diagram illustrating an example of a system for implementing certain aspects of the present technology. In particular, FIG. 18 illustrates an example of computing system 1800, which can be for example any computing device making up internal computing system, a remote computing system, a camera, or any component thereof in which the components of the system are in communication with each other using connection 1805. Connection 1805 can be a physical connection using a bus, or a direct connection into processor 1810, such as in a chipset architecture. Connection 1805 can also be a virtual connection, networked connection, or logical connection.

In some aspects, computing system 1800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1800 includes at least one processing unit (CPU or processor 1810) and connection 1805 that couples various system components including system memory 1815, such as read-only memory (ROM) 1820 and random-access memory (RAM) 1825 to processor 1810. Computing system 1800 can include a cache 1812 of high-speed memory connected directly with, in close proximity to, or integrated as part of processor 1810.

Processor 1810 can include any general-purpose processor and a hardware service or software service, such as services 1832, 1834, and 1836 stored in storage device 1830, configured to control processor 1810 as well as a special-purpose processor where software instructions are incorporated into the actual processor design. Processor 1810 may essentially be a completely self-contained computing system, containing multiple cores or processors, a bus, memory controller, cache, etc. A multi-core processor may be symmetric or asymmetric.

To enable user interaction, computing system 1800 includes an input device 1845, which can represent any number of input mechanisms, such as a microphone for speech, a touch-sensitive screen for gesture or graphical input, keyboard, mouse, motion input, speech, etc. Computing system 1800 can also include output device 1835, which can be one or more of a number of output mechanisms. In some instances, multimodal systems can enable a user to provide multiple types of input/output to communicate with computing system 1800. Computing system 1800 can include communications interface 1840, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1840 may also include one or more GNSS receivers or transceivers that are used to determine a location of the computing system 1800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1830 can include software services, servers, services, etc., that when the code that defines such software is executed by the processor 1810, it causes the system to perform a function. In some aspects, a hardware service that performs a particular function can include the software component stored in a computer-readable medium in connection with the necessary hardware components, such as processor 1810, connection 1805, output device 1835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for generating a mesh model, comprising: at least one memory; and at least one processor coupled to the at least one memory, wherein the at least one processor is configured to: obtain a plurality of identified parameters associated with a selected expression of a first face in a set of images, wherein a range of the identified plurality of parameters is divided into a plurality of buckets, and wherein each bucket of the plurality of buckets is associated with a respective class label; generate, by an encoder configured to generate a three-dimensional mesh model, a set of parameters describing a second face in at least one image; determine a bucket from the plurality of buckets for a parameter from the set of parameters; and classify the parameter from the set of parameters using a class label associated with the determined bucket.

Aspect 2. The apparatus of Aspect 1, wherein each bucket is defined based on an upper bound value for an identified parameter and a lower bound value for the identified parameter within the range of the plurality of identified parameters.

Aspect 3. The apparatus of any of Aspects 1-2, wherein the at least one processor is further configured to: determine a loss between a bucket to which an identified parameter is classified and an expected bucket; and fine-tune parameters of the encoder based on the determined loss.

Aspect 4. The apparatus of any of Aspects 1-3, wherein the encoder is pre-trained based at least in part on synthetic data.

Aspect 5. An apparatus for generating a mesh model, comprising: at least one memory; and at least one processor coupled to the at least one memory, wherein the at least one processor is configured to: generate, based on an obtained frame, a set of parameters for a three-dimensional (3D) mesh model using an encoder, wherein the encoder is trained based on whether a parameter, of the set of parameters, is classified within a bucket, and wherein the bucket is defined based on an upper bound value for the parameter and a lower bound value for the parameter; and generate the 3D mesh model based on the set of parameters for the 3D mesh model.

Aspect 6. The apparatus of Aspect 5, wherein the encoder is trained further based on a loss determined based on a comparison of the bucket the parameter is classified within and a ground truth bucket for the obtained frame.

Aspect 7. The apparatus of Aspect 6, wherein the loss is determined based on the upper bound value for the parameter and the lower bound value for the parameter.

Aspect 8. The apparatus of any of Aspects 5-7, wherein the upper bound value for the parameter and the lower bound value for the parameter are determined based on an appearance of the 3D mesh model within the upper bound value for the parameter and the lower bound value for the parameter.

Aspect 9. The apparatus of Aspect 8, wherein the upper bound value for the parameter and the lower bound value for the parameter are manually determined.

Aspect 10. The apparatus of any of Aspects 5-9, wherein the parameter, of the set of parameters, is selected based on an expression selected for fine-tuning.

Aspect 11. The apparatus of any of Aspects 5-10, wherein the bucket is assigned a label.

Aspect 12. A method for generating a mesh model, comprising: obtaining a plurality of identified parameters associated with a selected expression of a first face in a set of images, wherein a range of the identified plurality of parameters is divided into a plurality of buckets, and wherein each bucket of the plurality of buckets is associated with a respective class label; generating, by an encoder configured to generate a three-dimensional mesh model, a set of parameters describing a second face in at least one image; determining a bucket from the plurality of buckets for a parameter from the set of parameters; and classifying the parameter from the set of parameters using a class label associated with the determined bucket.

Aspect 13. The method of Aspect 12, wherein each bucket is defined based on an upper bound value for an identified parameter and a lower bound value for the identified parameter within the range of the plurality of identified parameters.

Aspect 14. The method of any of Aspects 12-13, further comprising: determining a loss between a bucket to which an identified parameter is classified and an expected bucket; and fine-tuning parameters of the encoder based on the determined loss.

Aspect 15. The method of any of Aspects 12-14, wherein the encoder is pre-trained based at least in part on synthetic data.

Aspect 16. A method for generating a mesh model, comprising: generating, based on an obtained frame, a set of parameters for a three-dimensional (3D) mesh model using an encoder, wherein the encoder is trained based on whether a parameter, of the set of parameters, is classified within a bucket, and wherein the bucket is defined based on an upper bound value for the parameter and a lower bound value for the parameter; and generating the 3D mesh model based on the set of parameters for the 3D mesh model.

Aspect 17. The method of Aspect 16, wherein the encoder is trained further based on a loss determined based on a comparison of the bucket the parameter is classified within and a ground truth bucket for the obtained frame.

Aspect 18. The method of Aspect 17, wherein the loss is determined based on the upper bound value for the parameter and the lower bound value for the parameter.

Aspect 19. The method of any of Aspects 16-18, wherein the upper bound value for the parameter and the lower bound value for the parameter are determined based on an appearance of the 3D mesh model within the upper bound value for the parameter and the lower bound value for the parameter.

Aspect 20. The method of Aspect 19, wherein the upper bound value for the parameter and the lower bound value for the parameter are manually determined.

Aspect 21. The method of any of Aspects 16-20, wherein the parameter, of the set of parameters, is selected based on an expression selected for fine-tuning.

Aspect 22. The method of any of Aspects 16-21, wherein the bucket is assigned a label.

Aspect 23. A non-transitory computer-readable medium having stored thereon instructions that, when executed by at least one processor, cause the at least one processor to perform operations according to any of Aspects 12-15.

Aspect 24. A non-transitory computer-readable medium having stored thereon instructions that, when executed by at least one processor, cause the at least one processor to perform operations according to any of Aspects 16-22.

Aspect 25. An apparatus for generating a mesh model, the apparatus including one or more means for performing operations according to any of Aspects 12-15.

Aspect 26. An apparatus for generating a mesh model, the apparatus including one or more means for performing operations according to any of Aspects 16-22.

Aspect 27. The method of any of Aspects 16-21, wherein the loss comprises a range-quantization loss determined based on a difference from a ground truth label.

Aspect 28. The method of any of Aspects 12-15, wherein the loss comprises a range-quantization loss determined based on a difference from a ground truth label.

Aspect 29. The Apparatus of any of Aspects 1-4, wherein the loss comprises a range-quantization loss determined based on a difference from a ground truth label. Aspect 30. The Apparatus of any of Aspects 5-11, wherein the loss comprises a range-quantization loss determined based on a difference from a ground truth label.

What is claimed is:

1. An apparatus for generating a mesh model, comprising:
at least one memory; and
at least one processor coupled to the at least one memory, wherein the at least one processor is configured to:
obtain a plurality of identified parameters associated with a selected expression of a first face in a set of images, wherein a range of the identified plurality of parameters is divided into a plurality of buckets, and wherein each bucket of the plurality of buckets is associated with a respective class label;
generate, by an encoder configured to generate a three-dimensional mesh model, a set of parameters describing a second face in an image;
determine a bucket from the plurality of buckets for a parameter from the set of parameters;
classify the parameter from the set of parameters using a class label associated with the determined bucket;
determine a loss between a bucket to which an identified parameter is classified and an expected bucket; and
fine-tune parameters of the encoder based on the determined loss.

2. The apparatus of claim 1, wherein each bucket is defined based on an upper bound value for an identified parameter and a lower bound value for the identified parameter within the range of the plurality of identified parameters.

3. The apparatus of claim 1, wherein the encoder is pre-trained based at least in part on synthetic data.

4. The apparatus of claim 1, wherein the parameter, of the set of parameters, is selected based on an expression selected for fine-tuning.

5. The apparatus of claim 1, wherein the bucket is assigned a label.

6. The apparatus of claim 1, wherein the loss comprises a range-quantization loss determined based on a difference from a ground truth label.

7. An apparatus for generating a mesh model, comprising:
at least one memory; and
at least one processor coupled to the at least one memory, wherein the at least one processor is configured to:
generate, based on an obtained frame, a set of parameters for a three-dimensional (3D) mesh model using an encoder, wherein the encoder is trained based on whether a parameter, of the set of parameters, is classified within a bucket, and wherein the bucket is defined based on an upper bound value for the parameter and a lower bound value for the parameter, wherein the encoder is trained further based on a loss determined based on a comparison of the bucket the parameter is classified within and a ground truth bucket for the obtained frame; and
generate the 3D mesh model based on the set of parameters for the 3D mesh model.

8. The apparatus of claim 7, wherein the loss is determined based on the upper bound value for the parameter and the lower bound value for the parameter.

9. The apparatus of claim 7, wherein the upper bound value for the parameter and the lower bound value for the parameter are determined based on an appearance of the 3D mesh model within the upper bound value for the parameter and the lower bound value for the parameter.

10. The apparatus of claim 7, wherein the parameter, of the set of parameters, is selected based on an expression selected for fine-tuning.

11. The apparatus of claim 7, wherein the bucket is assigned a label.

12. The apparatus of claim 7, wherein the loss comprises a range-quantization loss determined based on a difference from a ground truth label.

13. A method for generating a mesh model, comprising:
obtaining a plurality of identified parameters associated with a selected expression of a first face in a set of images, wherein a range of the identified plurality of parameters is divided into a plurality of buckets, and wherein each bucket of the plurality of buckets is associated with a respective class label;
generating, by an encoder configured to generate a three-dimensional mesh model, a set of parameters describing a second face in an image;
determining a bucket from the plurality of buckets for a parameter from the set of parameters;
classifying the parameter from the set of parameters using a class label associated with the determined bucket;
determining a loss between a bucket to which an identified parameter is classified and an expected bucket; and
fine-tuning parameters of the encoder based on the determined loss.

14. The method of claim 13, wherein each bucket is defined based on an upper bound value for an identified parameter and a lower bound value for the identified parameter within the range of the plurality of identified parameters.

15. The method of claim 13, wherein the encoder is pre-trained based at least in part on synthetic data.

16. The method of claim 13, wherein the parameter, of the set of parameters, is selected based on an expression selected for fine-tuning.

17. The method of claim 13, wherein the bucket is assigned a label.

18. The method of claim 13, wherein the loss comprises a range-quantization loss determined based on a difference from a ground truth label.
